(19) United States
(12) Patent Application Publication
(10) Pub. No.: US 2022/0295565 A1
(43) Pub. Date: Sep. 15, 2022

(54) Enhancements for New Radio Devices with a Reduced Number of Antenna Branches

(71) Applicant: Apple Inc., Cupertino, CA (US)

(72) Inventors: Hong HE, San Jose, CA (US); Dawei ZHANG, Saratoga, CA (US); Rafael L. RIVERA-BARRETO, Miami, FL (US); Tarik TABET, Carlsbad, CA (US); Wei ZENG, Saratoga, CA (US)

(21) Appl. No.: 17/654,470

(22) Filed: Mar. 11, 2022

Related U.S. Application Data
(60) Provisional application No. 63/160,367, filed on Mar. 12, 2021.

(51) Int. Cl. H04W 74/08; H04L 5/00; H04W 72/04

(52) U.S. Cl. CPC H04W 74/0833; H04L 5/0048; H04W 72/0413; H04W 72/0446

(57) ABSTRACT

A user equipment (UE) is configured to receive a system information block (SIB) from a base station, wherein a dedicated set of physical random access channel (PRACH) resources for redcap devices are explicitly configured in the SIB and transmit, in response to the SIB, an indication to the base station that the UE is a reduced capability (redcap) device.

### PRIORITY CLAIM/INCORPORATION BY REFERENCE

This application claims priority to U.S. Provisional Application Ser. No. 63/160,367 filed on Mar. 12, 2021 and entitled “Enhancements for New Radio Devices with a Reduced Number of Antenna Branches,” the entirety of which is incorporated herein by reference.

### BACKGROUND

A new radio (NR) network may support reduced capability (redcap) devices. Generally, a redcap device is not configured with the same features as a legacy NR device. For example, compared to a legacy NR user equipment (UE), a redcap device may include a reduced number of antenna branches.

Redcap device features such as, but not limited to, the reduced number of antenna branches provide benefits for cost and/or complexity reduction. However, from the perspective of the network operator, reducing the number of UE antenna branches may result in a loss of network capacity and spectral efficiency. To improve support for redcap devices, there is a need for enhancements that adequately balance cost reduction, implementation feasibility and network performance.

### SUMMARY

Some exemplary embodiments are related to a processor of a user equipment (UE) configured to perform operations. The operations include receiving a system information block (SIB) from a base station, wherein a dedicated set of physical random access channel (PRACH) resources for redcap devices are explicitly configured in the SIB and transmitting, in response to the SIB, an indication to the base station that the UE is a reduced capability (redcap) device.

Other exemplary embodiments are related to a user equipment (UE) having a transceiver configured to communicate with a network and a processor communicatively coupled to the transceiver and configured to perform operations. The operations include receiving a system information block (SIB) from a base station, wherein a dedicated set of physical random access channel (PRACH) resources for redcap devices are explicitly configured in the SIB and transmitting, in response to the SIB, an indication to the base station that the UE is a reduced capability (redcap) device.

Still further exemplary embodiments are related to a processor of a base station configured to perform operations. The operations include transmitting, to a user equipment (UE), a system information block (SIB) from a base station, wherein a dedicated set of physical random access channel (PRACH) resources for redcap devices are explicitly configured in the SIB and receiving, from the UE in response to the SIB, an indication that the UE is a reduced capability (redcap) device.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows two tables that each illustrate an examples of redcap device type definitions according to various exemplary embodiments.

FIG. 4 shows an example of abstract syntax notation one (ASN.1) for implementing dedicated physical ransom access channel (PRACH) resources for new radio (NR) reduced capacity redcap devices.

FIG. 5 shows an example of the relationship between PRACH resources for legacy UEs and PRACH resources for redcap devices according to various exemplary embodiments.

FIG. 6 shows a signaling diagram for reporting redcap device type according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing enhancements that are configured to improve support for new radio (NR) devices with a reduced number of antenna branches.

The exemplary embodiments are described with regard to NR reduced capability (redcap) devices. The term “NR redcap device” generally refers to a third generation partnership (3GPP) concept for NR devices that have a lower cost and/or complexity compared to legacy NR devices. Redcap devices may be configured with features such as, but not limited to, a reduced number of antenna branches compared to legacy NR devices, bandwidth reduction compared to legacy NR devices, half-duplex frequency division duplex (FDD) capabilities, relaxed processing time compared to legacy NR devices and relaxed processing capability compared to legacy NR devices. These features may provide cost and/or complexity reduction benefits.

Throughout this description, the terms “user equipment (UE)” and “redcap device” may be used interchangeably to represent any electronic component that may establish a connection to a network and is equipped with capabilities that may be characterized as 3GPP NR redcap device capabilities. Therefore, the terms “UE” and “redcap device” as described herein are not used to represent any type of UE. Instead, these terms are used to identify a particular type of NR UE that is distinct from a legacy NR UE.

The exemplary embodiments include mechanisms configured to improve support for NR redcap devices. Generally, cost reduction may be increased by decreasing the number of antenna branches at the redcap device. In addition, decreasing the number of antenna branches may also be beneficial for implementation feasibility. For instance, the physical size of the redcap device may put a limit on the number of components (e.g., antenna branches, etc.) that may fit within the device.

From the perspective of the network operator, redcap device features may have a negative impact on network capacity and/or spectral efficiency. The magnitude of the impact may depend on factors such as, the proportion of redcap devices to legacy devices, the network traffic characteristics and the number of antenna branches per redcap device. The exemplary embodiments include enhancements for NR redcap devices that are configured to adequately balance cost reduction, implementation feasibility and network performance. The exemplary enhancements may be used in conjunction with other currently implemented redcap NR mechanisms, future implementation of redcap NR mechanisms or independently from other redcap NR mechanisms.

It has been identified that if the data rate of a NR redcap device with one receive (RX) antenna branch is small relative to an enhanced mobile broadband (eMBB) device, the redcap device may be equipped with one RX antenna branch and not cause a significant degradation to the network capacity or the throughput of eMBB users in the same network. Some of the exemplary embodiments described herein leverage this concept by utilizing techniques that are configured to restrict NR redcap devices from consuming a certain data rate based on the number of antenna branches at the redcap device.

In one aspect, the exemplary embodiments include implementing a set of redcap device types. For example, a redcap device may be characterized as “redcap device type 1” or “redcap device type 2.” Each redcap device type or category may be defined based on two or more parameters and may be associated with specific capabilities. In a second aspect, the exemplary embodiments include techniques for the redcap device to report its redcap device type to the network. Specific examples of these exemplary aspects will be described in more detail below.

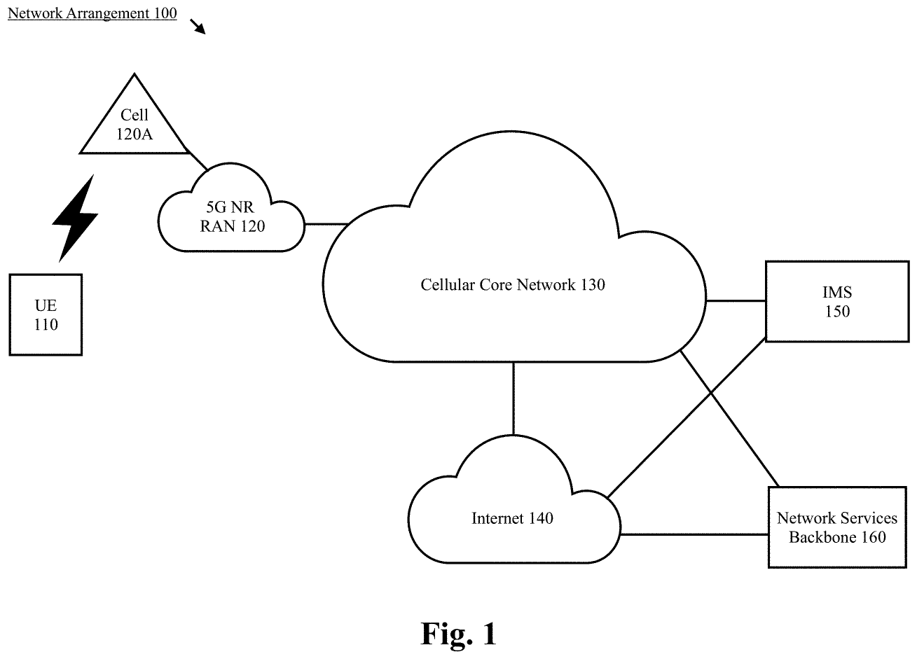

FIG. 1 shows an exemplary network arrangement 100 according to various exemplary embodiments. The exemplary network arrangement 100 includes a UE 110. As indicated above, in this description the term “UE” may be used interchangeably with the term “redcap device” to represent any electronic component that may establish a connection to a network and is equipped with capabilities that may be characterized as 3GPP NR redcap device capabilities. To provide some specific examples, a redcap device may be associated with certain use cases such as, but not limited to, industrial wireless sensors, video surveillance and wearables (e.g., medical devices, augmented reality goggles, virtual reality googles, smart watches, etc.). An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR RAN 120 via a cell 120A. The cell 120A may include one or more communication interfaces to exchange data and/or information with camped UEs, the 5G NR RAN 120, the cellular core network 130, the internet 140, etc. Further, the cell 120A may include a processor configured to perform various operations. For example, the processor may be configured to perform operations related requesting capability information, processing capability information and facilitating network support of redcap NR devices. However, reference to a processor is merely provided for illustrative purposes. The operations of the cell 120A may also be represented as a separate incorporated component of the cell or may be a modular component coupled to the node, e.g., an integrated circuit with or without firmware. For example, the integrated circuit may include input circuitry to receive signals and processing circuitry to process the signals and other information. In addition, in some cells, the functionality of the processor is split among two or more processors such as a baseband processor and an applications processor. The exemplary embodiments may be implemented in any of these or other configurations of a cell.

It will be further understood that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell or base station. As mentioned above, the use of the 5G NR RAN 120 is for illustrative purposes and any appropriate type of RAN may be used.

In addition to the NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the evolved packet core (EPC) and/or the fifth generation core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

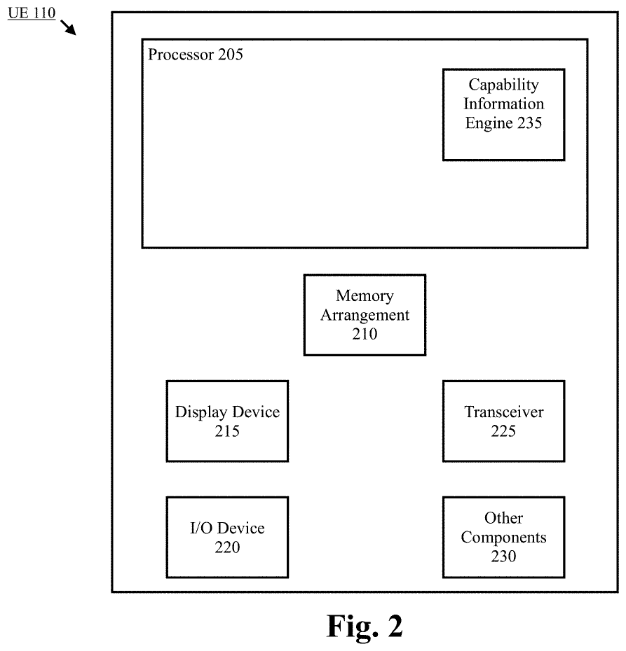

FIG. 2 shows an exemplary UE 110 according to various exemplary embodiments. The UE 110 will be described with regard to the network arrangement 100 of FIG. 2. The UE 110 may include a processor 205, a memory arrangement 210, a display device 215, an input/output (I/O) device 220, a transceiver 225 and other components 230. The other components 230 may include, for example, one or more antenna branches, an audio input device, an audio output device, a power supply, a data acquisition device, ports to electrically connect the UE 110 to other electronic devices, etc.

The processor 205 may be configured to execute a plurality of engines of the UE 110. For example, the engines may include a capability information engine 235. The capability information engine 235 may perform various operations related to the UE 110 reporting to the network that the UE 110 is a redcap device and/or a particular redcap device type.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

As mentioned above, in one aspect, the exemplary embodiments include implementing a set of two or more redcap device types. To provide a general example, the total population of redcap devices may be categorized as a first type of redcap device or a second type of redcap device that is distinct from the first type of redcap device. Therefore, NR redcap devices may refer to UEs with specific capabilities or features that are distinct from legacy NR UEs and may be further characterized by their corresponding redcap device type.

Throughout this description, to illustrate the concept of different NR redcap device types, reference may be made to “redcap device type 1” and “redcap device type 2.” However, these terms are merely provided for illustrative purposes. The exemplary embodiments may utilize any type of labeling or classifying to distinguish between different redcap device types. In addition, those skilled in the art will understand how the exemplary concepts described herein may apply to scenarios in which there are more than two redcap device types.

During operation, the UE 110 may indicate to the network a particular redcap device type (e.g., redcap device type 1, redcap device type 2). As will be described in more detail below, this indication may be associated with two or more DL physical layer parameters. For instance, the redcap device type 1 and redcap device type 2 may be hard encoded into the 3GPP specification. Thus, when the UE 110 reports redcap device type 1 or redcap device type 2, the network is aware of two or more physical layer parameter values relevant to the UE 110. The UE 110 and/or the network may then perform subsequent operations based on the physical layer parameter values associated with the redcap device type of the UE 110.

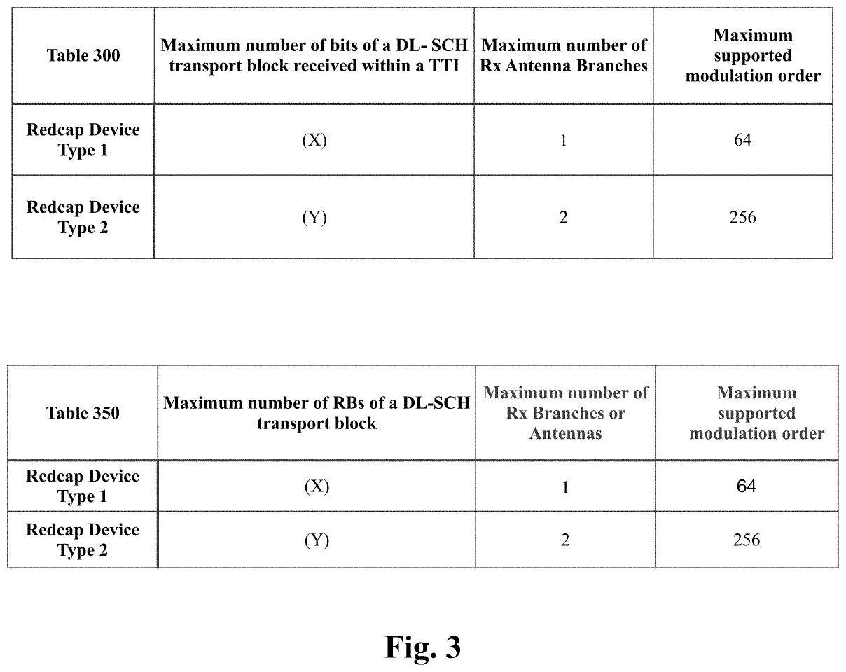

Each redcap device type may be defined separately for a different frequency range (FR) and may be based on two or more physical layer parameters. Initially, several example parameters will be described below. Subsequently, specific examples of redcap device type definitions will be described with regard to tables 300 and 350 in FIG. 3. However, the exemplary embodiments are not limited to the redcap device type examples in tables 300, 350 or redcap device types based on two or more of the following parameters. The exemplary embodiments may apply to a redcap device type that is based on any combination of two or more appropriate parameters.

One exemplary parameter relates to the number of RX antenna branches (or antennas). In some embodiments, the number of RX antenna branches is explicitly used to define redcap device type (RDT). In other embodiments, since there may be a correlation between the number of RX branches and a maximum number of supported layers for spatial multiplexing in the downlink (DL), the maximum number of supported layers for spatial multiplexing in the DL may be used to define and/or indicate a redcap device type. For example, if the UE 110 supports a maximum of one DL multiple input multiple output (MIMO) layer it may be assumed that the UE 110 is equipped with one RX antenna branch. To provide another example, if the UE 110 supports a maximum of two DL MIMO layers it may be assumed that the UE 110 is equipped with two RX antenna branches.

Another exemplary parameter relates to a maximum number of bits for a DL-shared channel (SCH) transport block received within a transmission time interval (TTI). This parameter may be used to place an upper limit on the maximum data rate supported by a redcap device type. In some embodiments, a maximum number of resource blocks (RBs) or a maximum bandwidth may be used to define a redcap device type. The appropriate maximum achievable data rate for a given number of RBs or bandwidth may be computed by using a hard encoded equation in conjunction with other parameters such as, but not limited to, a maximum number of RX branches, a maximum number of MIMO layers, a maximum supported modulation order and overhead (OH) assumption.

Another exemplary parameter relates to a maximum supported modulation order. For example, a maximum supported modulation order may be 64 quadrate amplitude modulation (QAM) or 256 QAM. In some embodiments, the maximum supported modulation order (or any other parameter relevant to the redcap device capabilities) may be separately indicated as part of a UE capability report instead of being indicated based on a redcap device type definition.

FIG. 3 shows two tables 300, 350 that each illustrate an example of redcap device type definitions according to various exemplary embodiments.

Table 300 provides one example of two redcap device type definitions, e.g., redcap device type 1 and redcap device type 2. In this example, redcap device type 1 is defined as a NR redcap device that is configured with a maximum number of bits (X) for a DL-SCH transport block received within a TTI, one RX antenna branch and a maximum supported modulation order of 64 QAM. Redcap device type 2 is defined as a NR redcap device that is configured with a maximum number of bits (Y) for a DL-SCH transport block received within a TTI, two RX antenna branches and a maximum supported modulation order of 256 QAM.

These redcap device type definitions may be hard encoded into a protocol, specification or standard such that when the UE 110 reports a redcap device type to the network and/or provides an indication of a physical layer parameter value associated with a redcap device type, the network is aware of the physical layer parameter values relevant to the UE 110.

As indicated above, some physical layer parameters may be reported to the network using a different mechanism. To provide an example within the context of the table 300, the UE 110 may report 64 QAM as part of a UE capability report. The UE 110 may separately indicate redcap device type 1 using the exemplary approaches described below or any other appropriate technique. In this example, since QAM is reported separately, redcap device type 1 may indicate to the network that the UE 110 is equipped with a single RX antenna branch and a maximum number of bits (X) for a DL-SCH transport block received within a TTI because these two physical layer parameter values are associated with the redcap device type 1.

In the example of table 300, redcap device type 1 may be beneficial for smart watches because their smaller form factor may place a physical limitation on being able to use more than one RX antenna branch. In addition, redcap device type 2 may be beneficial for other wearables because more antenna branches may allow the redcap device to achieve the demanding peak data rates associated with more complex wearables.

Table 350 also provides an example of two redcap device type definitions, e.g., redcap device type 1 and redcap device type 2. In contrast to the table 300, the table 350 uses a maximum number of RBs for a DL-SCH transport block to define a redcap device type. In this example, redcap device type 1 is defined as a NR redcap device that is configured with a maximum number of RBs (X) for a DL-SCH transport block, one RX antenna branch and a maximum supported modulation order of 64 QAM. Redcap device type 2 is defined as a NR redcap device that is configured with a maximum number of RBs (Y) for a DL-SCH transport block, two RX antenna branches and a maximum supported modulation order of 256 QAM. In some embodiments, the maximum number of RBS (Y) may be implicitly determined based on the bandwidth required for redcap devices, e.g., 20 MHZ bandwidth for FR1 and 100 MHZ for FR2.

The redcap device type 1 and redcap device type 2 definitions in table 300 and table 350 are merely provided for illustrative purposes and are not intended to limit the exemplary embodiments in any way. The exemplary embodiments may apply to a redcap device type that is based on any appropriate physical layer parameter and corresponding value.

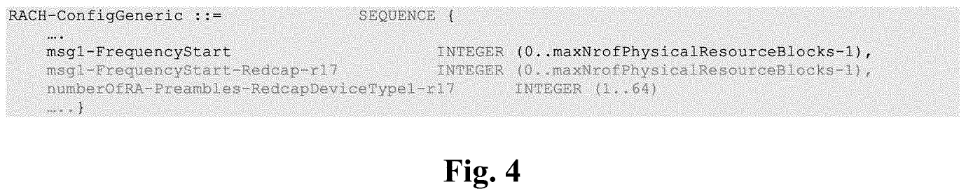

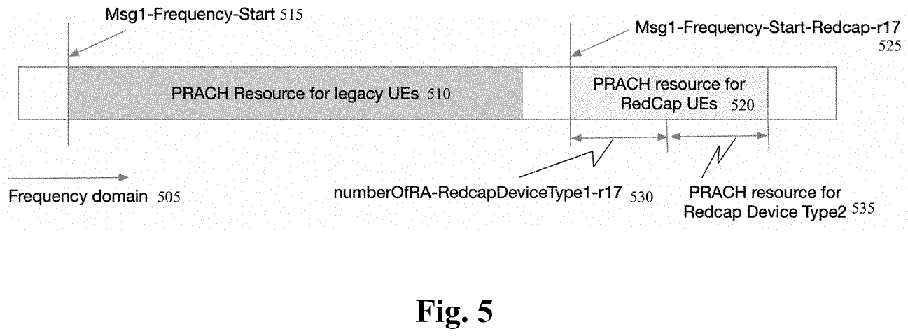

In a second aspect, the exemplary embodiments include techniques for reporting a redcap device type. In one approach, a dedicated set of physical random access channel (PRACH) resources may be explicitly configured for NR redcap devices. For example, dedicated PRACH message 1 (msg1) resources in a SIB1 may be configured for NR redcap devices to indicate its device type. In some embodiments, the PRACH resources configured by SIB1 for NR redcap devices may be divided into (M) groups where M is the number of redcap device types. For example, if there are two redcap device types (e.g., redcap device type 1 and redcap device type 2) M may be equal to two. This approach will be described in more detail below with regard to FIGS. 4-5.

FIG. 4 shows an example of abstract syntax notation one (ASN.1) for implementing dedicated PRACH resources for NR redcap devices. This example assumes that there are two defined redcap device types (e.g., redcap device type 1 and redcap device type 2) and thus, M may be equal to two.

In addition, new information elements (IEs) may be introduced to SIB1, which is used by the UE 110 to report redcap device type by selecting a corresponding PRACH resource during an initial access procedure. One exemplary IE may be referred to as “msg1-FrequencyStart-Redcap” IE that represents an offset of a lowest redcap-specific PRACH transmission occasion in a frequency domain with respect to physical resource block (PRB) 0. This value may be configured such that the corresponding RACH resource is entirely within the bandwidth of the redcap uplink (UL) bandwidth part (BWP). Another exemplary IE may be referred to as “numberOfRA-RedcapDeviceType1” and represents the number of contention based (CB) preambles per synchronization signal block (SSB) for a particular redcap device type (e.g., redcap device type 1). Similarly, another exemplary IE may be referred to as “numberOfRA-RedcapDeviceType2” and represents the number of CB preambles per SSB for a different redcap device type (e.g., redcap device type 2). In some embodiments, the PRACH resources that are not in range of “numberofRA-RedcapDeviceType1” is assumed to be used by redcap devices to indicate redcap device type 2.

FIG. 5 shows an example of the relationship between PRACH resources for legacy UEs and PRACH resources for redcap devices according to various exemplary embodiments. FIG. 5 includes the frequency domain 505. A portion of the frequency domain 505 is occupied by PRACH resources for legacy UEs 510 the start of which may be identified by “msg1-frequency-start” 515.

A second portion of the frequency domain 505 is occupied by PRACH resources for redcap devices 520 the start of which may be identified by “msg1-frequency-start-redcap-r17” 525. In addition, the PRACH resources for redcap devices 520 may be further divided into two sub-groups using IE “numberOfRA-RedcapDeviceType1” 530. In some embodiments, it may be implied that the redcap specific PRACH resources that are not within the range indicated by the IE numberOfRA-RedcapDeviceType1 530 may be used by the other redcap device types. In other embodiments, the redcap specific PRACH resources for other redcap device types may be explicitly signaled to the UE 110. The portion of the PRACH configured for the other redcap device is shown with reference number 535.

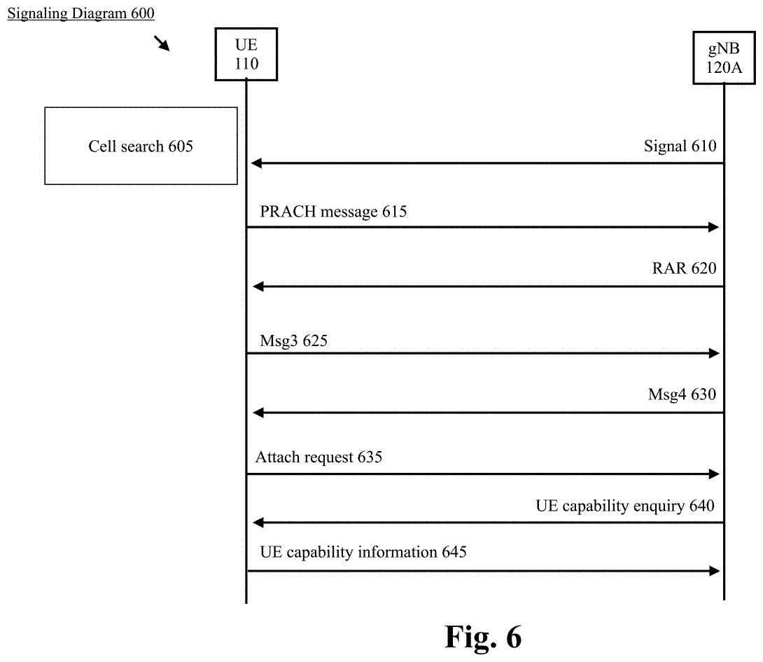

In another approach, the redcap device type may be reported by the UE 110 to the network as part of message 3 (msg3) of contention based RACH procedure by using one or two bits depending on the number of redcap device types. For two step RACH procedures, the redcap device type may be indicated using message A (msgA) on the PUSCH. A specific example of this approach will be provided below with regard to FIG. 6.

In a further approach, the redcap device type may be included in a registration procedure control message. For example, the redcap device type may be indicated in an attach request transmitted to a mobility management entity (MME). A specific example of this approach will also be provided below with regard to FIG. 6.

In another approach, the redcap device type may be included as part of a UE capability report. A specific example of this approach will also be provided below with regard to FIG. 6.

FIG. 6 shows a signaling diagram 600 for reporting redcap device type according to various exemplary embodiments. The signaling diagram 600 includes the UE 110 and the gNB 120A and shows multiple instances in which the UE 110 may report the redcap device type.

In 605, the UE 110 performs a cell search by scanning one or more frequencies. In 610, the UE 110 identifies a signal broadcast by the gNB 120A during the cell search.

In 615, the UE 110 transmit a PRACH message to the gNB 120A in response to identifying the signal in 610. In some embodiments this signal may be transmitted on a PRACH resource dedicated for redcap devices like the example discussed above with regard to FIGS. 4-5. Thus, in one approach, the UE 110 may report the redcap device type using this PRACH message. In other embodiments this signal may be a PRACH resource configured for multiple types of UEs (e.g., redcap devices, eMBB devices, etc.) and the redcap device type indication may be provided in a subsequent message.

In 620, the gNB 120A may transmit a random access response (RAR) to the UE 110. In 625, the UE 110 may transmit a msg3 to the gNB 120A. In one approach, the msg3 may be used by the UE 110 to indicate a redcap device type to the network.

In 630, the gNB 120A may transmit a msg4 to the UE 110. In 635, the UE 110 may transmit an attach request to the gNB 120A. In one approach, the attach request may be used to indicate a redcap device type to the network.

In 640, the gNB 120A may transmit a UE capability enquiry message to the UE 110. In 645, the UE 110 may transmit UE capability information to the gNB 120A. In one approach, the UE capability information may be configured to include an indication of a redcap device type.

In some embodiments, the network (e.g., cell 120A) may configure using SIB1 or any other appropriate type of message for the UE 110 to use either PRACH (msg1) resource selection for redcap device type reporting or msg3 for redcap device type reporting. Since msg1 and msg3 may be use case dependent, this enhancement allows the network to adapt redcap device reporting to the current deployment scenario. To provide an example, for msg3 coverage compensation or for DL physical channel coverage compensation in larger cell deployment (e.g., msg2 random access response), it may be beneficial to indicate the redcap device type in msg 1. On the other hand, in many scenarios, the coverage loss may be compensated by using a more robust configuration without a negative impact on performance. Thus, making msg1 configurable for redcap device type reporting may provide an adaptive signaling framework.

In some embodiments, using one of msg1 and msg 3 for redcap device type indication may be explicitly indicated through a dedicated IE in SIB1. In other embodiments, one of msg1 and msg3 may be defined as a default mode for redcap device type reporting. The network may then override the default mode using an indication in a SIB as described above. For example, if the default mode includes msg1 redcap device type reporting, the SIB may indicate to the UE 110 that the default mode is to be replaced with a different redcap device type reporting mode (e.g., msg3).

### Examples

In a first example, a processor of a user equipment (UE) is configured to perform operations comprising receiving a system information block (SIB) from a base station and transmitting an indication of a reduced capability (redcap) device type to the base station based on the configurations provided in the SIB, wherein there are multiple different redcap device types and each redcap device type is associated with i) a number of receive antenna branches and ii) at least one further physical layer parameter value.

In a second example, the processor of the first example, wherein the at least one further physical layer parameter value is for a maximum number of bits of a downlink (DL)-shared channel (SCH) transport block received within a transmission time interval.

In a third example, the processor of the first example, wherein the at least one further physical layer parameter value is a maximum number of resource blocks (RBs) of a downlink (DL)-shared channel (SCH) transport block.

In a fourth example, the processor of the first example, wherein the at least one further physical layer parameter value is a maximum supported modulation order.

In a fifth example, the processor of the first example, wherein the association between the redcap device type and the number of receive antenna branches is based on a maximum number of supported layers for spatial multiplexing.

In a sixth example, the processor of the first example, wherein the SIB comprises a configuration of a dedicated set of physical random access channel (PRACH) resources for indication of redcap devices configured into multiple groups, each group corresponding to a respective one of the redcap device types.

In a seventh example, the processor of the first example, wherein the indication of the redcap device type is included in a message 3 (msg3) of a contention based random access channel (RACH) procedure.

In an eighth example, the processor of the first example, wherein the indication of the redcap device type is included in a message A (msgA) of a two-step random access channel (RACH) procedure.

In a ninth example, the processor of the first example, wherein the indication of the redcap device type is included in a control message associated with registration.

In a tenth example, the processor of the first example, wherein the indication of the redcap device type is included in an attach request.

In an eleventh example, the processor of the first example, wherein the indication of the redcap device type is included as part of UE capability reporting.

In a twelfth example, the processor of the first example, wherein the redcap device type reporting is configurable by a network via the SIB.

In a thirteenth example, the processor of the first example, wherein one of message 1 (msg1) and message 3 (msg3) is explicitly configured in the SIB for the indication of redcap device type reporting.

In a fourteenth example, the processor of the first example, wherein the SIB includes a configuration of a redecap device type reporting mode that replaces a default redcap device type reporting mode.

In a fifteenth example, a processor of a base station is configured to perform operations comprising transmitting a system information block (SIB) to a user equipment (UE) and receiving an indication of a reduced capability (redcap) device type from the UE based on the configurations provided in the SIB, wherein there are multiple different redcap device types and each redcap device type is associated with i) a number of receive antenna branches and ii) at least one further physical layer parameter value.

In a sixteenth example, the processor of the fifteenth example, wherein the redcap device type reporting mode to be used by the UE is configurable by the SIB.

In a seventeenth example, the processor of the fifteenth example, wherein one of message 1 (msg1) and message 3 (msg3) is explicitly indicated in the SIB for the indication of redcap device type reporting.

In an eighteenth example, the processor of the fifteenth example, wherein the SIB includes a configuration of a redcap device type reporting mode that replaces a default redcap device type reporting mode.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
receiving a system information block (SIB) from a base station, wherein a dedicated set of physical random access channel (PRACH) resources for redcap devices are explicitly configured in the SIB; and
transmitting, in response to the SIB, an indication to the base station that the UE is a reduced capability (redcap) device.

2. The processor of claim 1, wherein the transmitting is performed using a portion of the dedicated set of PRACH resources.

3. The processor of claim 1, wherein message 1 (msg1) of a four step RACH process is explicitly indicated in the SIB for indicating the redcap device.

4. The processor of claim 1, wherein the PRACH resource is entirely within a bandwidth of a redcap uplink (UL) bandwidth part (BWP).

5. The processor of claim 1, wherein the dedicated set of PRACH resources comprises a partition of a PRACH preamble.

6. The processor of claim 5, wherein the PRACH preamble is a contention based preamble.

7. The processor of claim 1, message A (msgA) of a two step RACH process is explicitly indicated in the SIB for indicating the redcap device.

8. A user equipment (UE), comprising:
a transceiver configured to communicate with a network; and
a processor communicatively coupled to the transceiver and configured to perform operations comprising:
receiving a system information block (SIB) from a base station, wherein a dedicated set of physical random access channel (PRACH) resources for redcap devices are explicitly configured in the SIB; and
transmitting, in response to the SIB, an indication to the base station that the UE is a reduced capability (redcap) device.

9. The UE of claim 8, wherein the transmitting is performed using a portion of the dedicated set of PRACH resources.

10. The UE of claim 8, wherein message 1 (msg1) of a four step RACH process is explicitly indicated in the SIB for indicating the redcap device.

11. The UE of claim 8, wherein the PRACH resource is entirely within a bandwidth of a redcap uplink (UL) bandwidth part (BWP).

12. The UE of claim 8, wherein the dedicated set of PRACH resources comprises a partition of a PRACH preamble.

13. The UE of claim 12, wherein the PRACH preamble is a contention based preamble.

14. The UE of claim 8, message A (msgA) of a two step RACH process is explicitly indicated in the SIB for indicating the redcap device.

15. A processor of a base station configured to perform operations comprising:
transmitting, to a user equipment (UE), a system information block (SIB) from a base station, wherein a dedicated set of physical random access channel (PRACH) resources for redcap devices are explicitly configured in the SIB; and
receiving, from the UE in response to the SIB, an indication that the UE is a reduced capability (redcap) device.

16. The processor of claim 15, wherein the indication is received on a portion of the dedicated set of PRACH resources.

17. The processor of claim 15, wherein the SIB explicitly indicates that message 1 (msg1) of a four step RACH process is to be used for the indication.

18. The processor of claim 15, wherein the PRACH resource is entirely within a bandwidth of a redcap uplink (UL) bandwidth part (BWP).

19. The processor of claim 15, wherein the dedicated set of PRACH resources comprises a partition of a PRACH preamble.

20. The processor of claim 19, wherein the PRACH preamble is a contention based preamble.
